(19) United States
(12) Patent Application Publication
(10) Pub. No.: US 2022/0207957 A1
(43) Pub. Date: Jun. 30, 2022

(54) ELECTRONIC GAMING ARRANGEMENT ALLOWING REMOTE PLAYERS TO PARTICIPATE IN A GAME PLAYED AT A GAMING TABLE

(71) Applicant: TANGIAMO TOUCH TECHNOLOGY AB, Göteborg (SE)

(72) Inventors: Linh THAI, Göteborg (SE); Harald BÖRSHOLM, Göteborg (SE); Anton BENGTSSON, Hovås (SE)

(73) Assignee: TANGIAMO TOUCH TECHNOLOGY AB, Göteborg (SE)

(21) Appl. No.: 17/601,808

(22) PCT Filed: Apr. 16, 2020
(86) PCT No.: PCT/SE2020/050391

§ 371 Date: Oct. 6, 2021

(30) Foreign Application Priority Data
Apr. 16, 2019 (SE) 1950473-7

(51) Int. Cl. G07F 17/32

(52) U.S. Cl. CPC G07F 17/3223; G07F 17/3211; G07F 17/3239; G07F 17/322

(57) ABSTRACT

The present disclosure generally relates to an electronic gaming arrangement, specifically adapted to capture gaming information at a gaming table, where the gaming information may be distributed to remotely arranged participants or players in turn using electronic devices. The electronic gaming arrangement comprises a display screen, an image capturing device and a control unit that are all integrated in a housing. The present disclosure also relates to a gaming system comprising such an electronic gaming arrangement.

### TECHNICAL FIELD

The present disclosure generally relates to an electronic gaming arrangement, specifically adapted to capture gaming information at a gaming table, where the gaming information may be distributed to remotely arranged participants or players in turn using electronic devices. The present disclosure also relates to a gaming system comprising such an electronic gaming arrangement.

### BACKGROUND OF THE PRESENT DISCLOSURE

Gaming systems for use in a gaming environment, such as a casino, have a limited maximum number of participants able to play the game simultaneously due to, for example, the size of the specific gaming site or other physical limitations to the gaming system. There is also a disadvantage that a certain game might also be played at a specific location at the casino, and therefore the participant might have to find his way through the entire casino to locate the specific game he or she wants to play.

A solution to this problem is found in U.S. Ser. No. 10/223,862, by the applicant, which provides a system for controlling and managing bets for a game played remotely from where the underlying live game is played. The system comprises an underlying gaming table, a camera and a plurality of player each equipped with an electronic device comprising a display screen. The gaming information from the gaming table is e.g. acquired by means of the camera. This solution gives the participants the opportunity to play the desired game at a remote location, and also provides a game suitable for a large plurality of participants.

Even though the remote gaming system provided in U.S. Ser. No. 10/223,862 is of great interest, the solution relies on the installation of a completely new system to e.g. the casino. Accordingly, there would be of interest to also allow the remote functionality to be used in relation to previously installed gaming tables.

### SUMMARY OF THE PRESENT DISCLOSURE

According to an aspect of the present disclosure, the above is at least partly alleviated by an electronic gaming arrangement to be positioned in relation to a gaming table, the gaming table comprising at least one of an active gaming area and a gaming device adapted to generate an outcome, the electronic gaming arrangement comprising a display screen adapted to present a graphical user interface (GUI), an image capturing device, a control unit connected to the display screen and the image capturing device, a housing adapted to integrate the display screen, the image capturing device and the control unit, and mounting means for arranging the electronic gaming arrangement in an elevated position in relation to at least one of the active gaming area and the gaming device, wherein the control unit is adapted to control the image capturing device to capture an image stream of at least one of a portion of the active area and the gaming device, determine an outcome based on the captured image stream, and distribute, using a networked connection, at least a portion of the image stream and the outcome to at least one of a first electronic device operated by a player or a server, the first electronic device and the server arranged remotely from the gaming table.

By means of the present disclosure, it is possible to allow “remote players” to “participate” in a game at a physical game site, i.e. at the gaming table, at an “adjacent location” (e.g. in the same room or same casino) as the gaming table, or at a different location as compared to the gaming table (e.g. at another casino, at home, etc.). Hereby, the system allows for a large plurality of players to simultaneously participate in a game being played at the gaming table.

In addition, by means of the present disclosure it is possible to retrofit an already installed gaming table, such as at a casino, with the electronic gaming arrangement, thereby allowing the already installed gaming table to be “visible” online, such as at an online casino.

The gaming device should, in the context of the present application, be understood to relate to a gaming device for any type of game played in a gaming environment, such as roulette, craps, baccarat, blackjack, etc. The type of game played should not be limited for the use of the above-defined gaming table or gaming arrangement. Rather, it should be understood that the expression “gaming table” should be interpreted broadly, including any form of setup for playing a game, such as in a casino environment. As such, examples of gaming tables include roulette table, craps table, baccarat table or blackjack table. However, other types of setups such as slot machines, etc. are equally within the context of the expression gaming table.

The expression “player” should be understood to mean a player of the game, who participates at the game using his/her remote first electronic device or being part of the game played at the gaming table. The player operating the remote first electronic device should therefore be understood to mean a player who interacts with the gaming table by participating remotely, from a distance of the gaming table. This could for example be in a hotel room, at home or in other parts of the gaming environment, such as at the same casino where the gaming table is located. The specific location of the player operating the remote first electronic device is not limited to the scope of the present application. Further players may of course participate at the gaming table.

The image capturing device may visually acquire the gaming activity at the local gaming device and provide the information to the remote server as well as to the player operating the remote first electronic device.

The expression “control unit” should be understood to include any type of computing device, such as an ASIC, a micro-processor, etc. It should also be understood that the actual implementation of such a processing circuitry may be divided between more than a single device/circuit. Furthermore, the networked connection may for example be a network connection such as the Internet.

During operation of the electronic gaming arrangement, it may in some embodiments be preferred to increase security of operation by reduce the processing being performed at the receiving end, e.g. at the first electronic device operated by the player or the remotely arranged server. That is, instead of allowing the operational logic to be implemented at the first electronic device or at the remotely arranged server, it is instead desired to implement such operational logic at the electronic gaming arrangement.

Such a configuration of the electronic gaming arrangement in turn results in the possibility to reduce the risk of the distributed information (e.g. the least a portion of the image stream and the outcome) being subject to unwanted manipulation at the first electronic device or at the remotely arranged server. A further advantage with such a configuration is that e.g. the first electronic device may be a “thin client”, meaning that only a limited amount of processing capability is needed for visualizing the least a portion of the image stream and the outcome and/or for interacting with the game played using the active gaming area and the gaming device provided in a vicinity of the electronic gaming arrangement.

In some embodiments it may be desirable to configure the information being distributed to the first electronic device or the remotely arranged server to further comprise an overall intermediate state of the game being played using the active gaming area and the gaming device provided in a vicinity of the electronic gaming arrangement. That is, rather than having the first electronic device or the remotely arranged server to “remember” the state of the game, this information is continuously provided to the first electronic device or the remotely arranged server. Such a configuration will further improve the overall security when operating the electronic gaming arrangement.

In some embodiments the outcome and/or the intermediate state of the game may be provided as metadata, as compared to being provided as e.g. a image data or similar. Possibly, the metadata could be verified at the first electronic device or the remotely arranged server in regards to its authenticity to ensure that the e.g. the information as presented to e.g. the player at the first electronic device is the latest state/outcome of the game. In some embodiments the communication between the electronic gaming arrangement and the first electronic device/the remotely arranged server may be encrypted.

In addition to the above, it may in some embodiments be desirable to configure the communication between e.g. the gaming device and the electronic gaming arrangement to be a one-way type of communication, where the electronic gaming arrangement is only allowed to receive information from the gaming device but not to manipulate the gaming device. Such a limitation will allow for the minimized risk of a security breach to the overall gaming environment due to the introduction of the electronic gaming arrangement, such as when retrofitting e.g. a gaming table with the electronic gaming arrangement according to the present disclosure. In an embodiment, the control unit is adapted to capture information indicative of wagering or betting at the active gaming area or otherwise in relation to the gaming device. The control unit may further adapted to distribute at least a portion of the information indicative of wagering or betting to the first remote electronic device. Correspondingly, the control unit may also be adapted to receive information indicative of wagering or betting from the first remote electronic device. Thus, in line with the present disclosure the control unit may receive and provide wagering or betting information from and to the remote electronic device, resulting in that the player using the remote electronic device may be allowed to take part of the game being played at the gaming table. In some embodiments, the information from the remote electronic device is not or just partly presented at the gaming table, to ensure that the gaming experience is not cluttered by remote players. The control unit may in some embodiment be adapted to form an indication of an average wagering or betting performed by a plurality of remote players using remote electronic devices. This indication may in turn be presented at the display unit comprised with the electronic gaming arrangement.

In possible embodiment of the present disclosure, the housing comprises a top end and a bottom end, and the image capturing device is integrated in a vicinity of the top end of the housing. As such, all the components of the electronic gaming arrangement may be ensured to be encapsulated, in a safe manner, in turn ensuring that no third-party is allowed to affect what is captured and then distributed to e.g. the remote player.

Preferably, the control unit may be further adapted to determine the outcome of the gaming device based on a content of the image stream. That is, the control unit may be equipped with image processing means adapted to perform e.g. auto recognition of winning number of a roulette wheel, or similarly in regard to any other game executed at the gaming table and/or in relation to the gaming device. However, in an alternative embodiment the outcome of the gaming device (and/or actions taken at the gaming table) may be generated by sensor means comprised with the gaming table. For example, a light sensor may be embedded in a roulette wheel to determine where a roulette ball is coming to an end position during a game.

Possibly, the image capturing device may be arranged to comprise a first and a second image sensor, the first image sensor adapted to capture an image stream of the gaming device and the second image sensor is adapted to capture an image stream of the active area. Accordingly, the electronic gaming arrangement may be arranged to capture two separate image streams, or a three-dimensional (3D) capture of the gaming table. The image capturing device comprises at least one comprises a lens arrangement, adapted to ensure that the image stream captured by the image capturing device is clearly focused to the desired portions of the gaming table, e.g. ensuring that the auto recognition of winning number of the roulette wheel, or similar may be performed with a high reliability.

In some embodiments of the present disclosure, it may be desirable to arrange the electronic gaming arrangement to further comprise an audio capturing device adapted to capture an environmental sound at the gaming table, and the control unit is further adapted to distribute at least a portion of the audio stream to the first remote electronic device. The audio capturing device may for example comprise one or a plurality of microphones, for example integrated in a vicinity of the bottom end of the electronic gaming arrangement. The audio information may in some embodiments include a “no more bets” indication provided by an operator/croupier at the gaming table. It should however be understood that such information may be indicated in different ways at the remote first electronic device.

Preferably, the control unit is adapted to implement server functionality, whereby e.g. the remote electronic device or the remote server may connect directly to the control unit to receive at least one of a portion of the image stream and the outcome from the gaming device. The remote server may on the other hand in one embodiment be implemented as a so-called cloud server. Thus, a location of the remote server or servers must not be explicitly defined. Advantageous following the use of a cloud-based solution is also the inherent redundancy achieved. The remote server is preferably adapted to ensure that further remote devices may be connected to the electronic gaming arrangement, through the remote server. In one embodiment the remote server is an online casino, receiving “live” information from the gaming table using the electronic gaming arrangement according to the present disclosure.

It is preferred to allow the electronic gaming arrangement as discussed above to form part of a gaming system, the gaming system further comprising the gaming table having the active gaming area and a gaming device adapted to generate an outcome.

Preferably, the gaming device is a roulette wheel comprising a roulette ball. However, the gaming device may also be one of a dice-shaking device and an electronic card shuffler comprising a plurality of playing cards. In regards to the gaming device being a dice-shaking device, it may for example be possible to adjust the information presented at the active area of the gaming table to switched between e.g. the dice game Craps, “Sic Bo” (also sometimes referred to as “Cussec”, “Tai Sai”, “Dai Siu”, “Big and Small” or “Hi-Lo”), Fish-Prawn-Crab/Hoo Hey How, Grand Hazard/Chuck-a-Luck/Birdcage, etc. The same of course counts for an implementation where the gaming device is a roulette wheel. Also, it could be possible to adapt the gaming table such that the type of gaming device may be exchanged, e.g. between different types of roulette wheels (e.g. single or double zero), etc.

As indicated above, the electronic gaming arrangement may be retrofitted to the gaming table, and as such forming the gaming system. Furthermore, it is desirable that the electronic gaming arrangement is arranged in an elevated position in relation to at least one of the active gaming area and the gaming device. The mounting means comprised with the electronic gaming arrangement, such as a pole or a stick embedding means for the networked communication as well as power supply for the electronic gaming arrangement. In an embodiment the mounting means is adjustable, for adapting the elevated position of the image capturing device to ensure that the image capturing device captures the desired portions of the gaming table. Such an embodiment is specifically useful in relation to retrofitting of an already installed gaming table.

In an embodiment the of the present disclosure, the gaming table comprises a multi-user touch interface. Such an interface may for example allow for the gaming table to be operated with a minor or none involvement as compared to a “classical gaming table”, where the operator is involved with receiving bets and providing payments to the players.

Preferably, the gaming system further comprises at least a first electronic device as discussed above. The first remote electronic device may comprise a receiver adapted to receive, over the networked communication, the image stream and the outcome to at least one first remote electronic device. Also, the first remote electronic device preferably comprises a display screen adapted to present the image stream and the outcome. Accordingly, a player operating the first remote electronic device may experience the live gaming activity at the gaming table.

The first electronic device may in one embodiment be a further gaming table, such as an automated gaming table comprising e.g. a multi-user touch interface. For example, in a roulette game, the roulette layout may comprise a multi-player touch screen, such that bets are executed by pressing the desired number on the roulette layout. The automated gaming table may in such an embodiment be provided with all necessary “gaming information” (such as information about the gaming device, outcome, video stream, etc.) at a display comprised with the automated gaming table. Thus, rather than having to resort to providing an operator or croupier, the automated gaming table may be operated without any external involvement in addition to the players at the automated gaming table. This may not only reduce the need of gaming chips, but also provides a game where bets and pay-out can be carried out in a fast and efficient manner.

The automated gaming table may in some embodiments be arranged at the same location as the “live” gaming table, such as at the same casino. However, it may also be possible to allow the automated gaming table (i.e. the first remote electronic device) to be arranged at another location, such as for example at another casino.

In an embodiment of the present disclosure, the gaming system further comprises at least a second remote electronic device, wherein the second electronic device is at least one of a tablet, a mobile phone, or a personal computer. Accordingly, the gaming system may comprise a mixture of players playing a game at the “live” gaming table, with players at an automated gaming table (or tables), as well as independent players at the same location as the live gaming table or in e.g. a home location.

Further features of, and advantages with, the present disclosure will become apparent when studying the appended claims and the following description. The skilled addressee realize that different features of the present disclosure may be combined to create embodiments other than those described in the following, without departing from the scope of the present disclosure.

### BRIEF DESCRIPTION OF THE DRAWINGS

The various aspects of the present disclosure, including its particular features and advantages, will be readily understood from the following detailed description and the accompanying drawing, in which:

FIG. 1 illustrates a perspective view of a gaming system according to a currently preferred embodiment of the present disclosure, and

FIGS. 2A-2D provides examples of remote electronic devices that may be connected to the gaming system as shown in FIG. 1.

### DETAILED DESCRIPTION

The present disclosure will now be described more fully hereinafter with reference to the accompanying drawings, in which currently preferred embodiments of the present disclosure are shown. This present disclosure may, however, be embodied in many different forms and should not be construed as limited to the embodiments set forth herein; rather, these embodiments are provided for thoroughness and completeness, and fully convey the scope of the present disclosure to the skilled addressee. Like reference characters refer to like elements throughout.

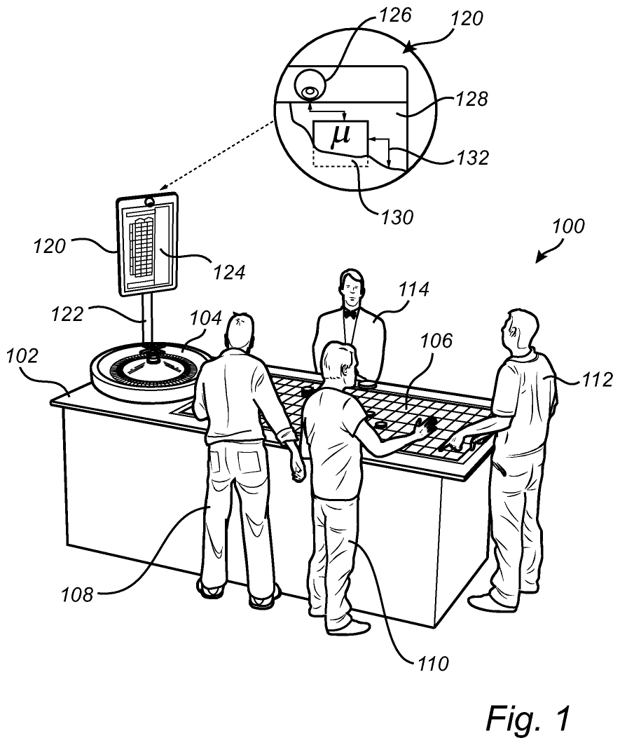

Referring now to the drawings and to FIG. 1 in particular, there is depicted a gaming system 100. The gaming system 100 comprises a gaming table 102 and a gaming device 102, in the illustrated embodiment in the form of a roulette wheel. The gaming table 102 further comprises an active gaming area 106. In the illustrated embodiment the active area is a classical manually operated roulette betting area.

The gaming table 102 is occupied by a plurality of local players 108, 110, 112 and an operator/croupier 114. The operator/croupier 114 ensures that the roulette game is performed in accordance to local rules and regulations, and is in charge of receiving bets from the local players 108, 110, 112 as well as distributing payments in case the local players 108, 110, 112 have been successful in their betting.

The gaming system 100 further comprises an electronic gaming arrangement 120 positioned in relation to the gaming table 102. The electronic gaming arrangement 120 is in the illustrated embodiment provided with a mounting pole 122 ensuring that the electronic gaming arrangement 120 is positioned in the desired elevated position.

The electronic gaming arrangement 120 further comprises a display screen 124 adapted to present a graphical user interface (GUI). The display 124 may typically present an outcome of the game being played at the gaming table 102, such as a present and historical outcome of the gaming device 104. In the illustrated embodiment where the gaming device 104 is a roulette wheel, the display 124 may show present and historical numbers in regard to where a roulette ball for the roulette wheel “landed”.

In line with the present disclosure, the electronic gaming arrangement 120 further comprises at least one camera 126 arranged at a top end of a housing 128 of the electronic gaming arrangement 120. The camera 126 is preferably completely integrated with the housing 128, where a lens of the camera 128 is only slightly extending from the housing 128. The camera 128 is in turn arranged to capture an image stream of at least one of a portion of the active area 106 and the gaming device 104.

In some embodiments the electronic gaming arrangement 120 may comprise more than a single display 124, such as two, three, or four displays. The plurality of displays may for example be facing towards in different directions. As such, two displays may be facing essentially in two opposite directions, three displays may be arranged in a triangular manner facing in three different directions (main direction 120 degrees different), etc.

The electronic gaming arrangement 120 further comprises at least one control unit 130, integrated within the housing 128. It is desirable that the components of the electronic gaming arrangement 120 are securely embedded with the housing 128 to ensure that e.g. the players etc. are not allowed to intervene with e.g. the camera 126, to thereby compromise image capturing.

The control unit may include a microprocessor, microcontroller, programmable digital signal processor or another programmable device. The control unit may also, or instead, each include an application specific integrated circuit, a programmable gate array or programmable array logic, a programmable logic device, or a digital signal processor. Where the control unit includes a programmable device such as the microprocessor, microcontroller or programmable digital signal processor mentioned above, the processor may further include computer executable code that controls operation of the programmable device.

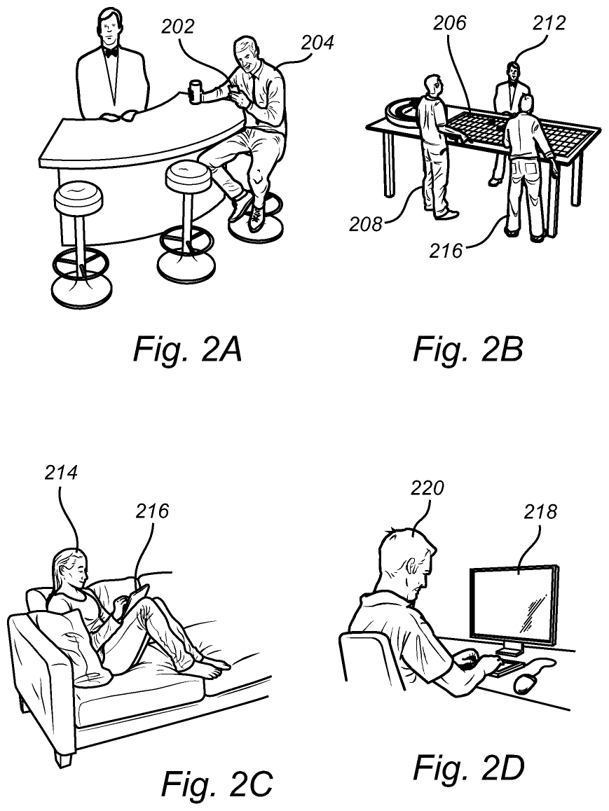

As discussed above, the control unit is adapted to distribute, using a networked connection 132 for example connected to the Internet, at least a portion of the image stream from the camera 126 and the outcome from the gaming device 104, collectively referred to as gaming information. The gaming information is in turned provided to a first remote electronic device operated by a thereto related player and/or a remote server. In FIGS. 2A-2D there are presented different types of first remote electronic device that may be adapted to receive the gaming information from the electronic gaming arrangement 120, using the networked connection, such as the Internet. The networked communication may be provided by wired or wireless communication, where wireless communication may be implemented using e.g. Wi-Fi, Bluetooth or similar.

Specifically, in FIG. 2A there is shown a first example of a first remote electronic device, where the first example of the first remote electronic device is illustrated as a mobile phone 202 operated by a player 204 arranged at a bar arranged at the same location, e.g. a casino, as the gaming table 102. The mobile phone 202, as well as other first remote electronic devices are arranged to comprise a processor and a display unit, where the display unit of e.g. the mobile phone 202 is adapted to present the gaming information from the electronic gaming arrangement 120. The mobile phone 202 may also be provided with a user interface for allowing the player 204 to interact with the game being played at the gaming table 102. Such interaction may for example include allowing the player 204 to place bets on the game being played at the gaming table 102. The bets placed by the player 204 may in some embodiments be visualized at the display 124 comprised with the electronic gaming arrangement 120.

In FIG. 2B there is illustrating another example of a first remote electronic device, namely another gaming table here in the form of an automated gaming table 206 occupied by a plurality of remote players 208, 210, 212. In the illustrated embodiment as shown in FIG. 2B no operator is present. The automated gaming table 206 comprises an electronic multi-player touch screen. Remote players 208, 210, 212 may as indicated in relation to FIG. 2A participates the game at the gaming table 102, placing bets by pressing at a desired number, card or the like, select his choice of action.

FIG. 2C presents still another example of a first remote electronic device, namely a remote player 214 operating a tablet 216 while in a home environment, a hotel, etc. FIG. 2D presents a similar type of situation, where the first remote electronic device is illustrated as a laptop 218 operated by a remote player 220.

In all of FIGS. 2A-2D, the respective display unit of the mobile phone 202, the automated gaming table 206, the tablet 216 and the laptop 220 may be arranged to e.g. show a real time image feed of the gaming device, such as the roulette wheel 104. However, due to regulations it may alternatively be possible to provide a representation of the operation of the roulette wheel 104, for example comprising a combination of live and virtually created video feeds fulfilling the requirements. As an example, in some cases the regulations restrict from providing a live video feed of a roulette wheel outside of the casino environment.

It should be understood that the listed types of first/second remote electronic device are solely for illustrative purpose. Accordingly, other type and/or a mixture or remote electronic devices are possible and within the scope of the present disclosure.

In summary, the present invention relates to an electronic gaming arrangement to be positioned in relation to a gaming table, the gaming table comprising at least one of an active gaming area and a gaming device adapted to generate an outcome, the electronic gaming arrangement comprising a display screen adapted to present a graphical user interface (GUI), an image capturing device, a control unit connected to the display screen and the image capturing device, a housing adapted to integrate the display screen, the image capturing device and the control unit, and mounting means for arranging the electronic gaming arrangement in an elevated position in relation to at least one of the active gaming area and the gaming device, wherein the control unit is adapted to control the image capturing device to capture an image stream of at least one of a portion of the active area and the gaming device, capture an outcome of the gaming device, and distribute, using a networked connection, at least a portion of the image stream and the outcome to at least one of a first electronic device operated by a player or a server, the first electronic device and the server arranged remotely from the gaming table.

By means of the present disclosure, it is possible to allow “remote players” to “participate” in a game at a physical game site, i.e. at the gaming table, at an “adjacent location” (e.g. in the same room or same casino) as the gaming table, or at a different location as compared to the gaming table (e.g. at another casino, at home, etc.). Hereby, the system allows for a large plurality of players to simultaneously participate in a game being played at the gaming table. The electronic gaming arrangement may for example be retrofitted to an already installed gaming table, such as at a casino, with the electronic gaming arrangement, thereby allowing the already installed gaming table to be “visible” online, such as at an online casino.

In addition, the control functionality of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

Although the figures may show a sequence the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps. Additionally, even though the present disclosure has been described with reference to specific exemplifying embodiments thereof, many different alterations, modifications and the like will become apparent for those skilled in the art. Further, a single unit may perform the functions of several means recited in the claims. In the claims, any reference signs placed between parentheses shall not be construed as limiting to the claim. Furthermore, in the claims, the word “comprising” does not exclude other elements or steps, and the indefinite article “a” or “an” does not exclude a plurality.

Variations to the disclosed embodiments can be understood and effected by the skilled addressee in practicing the claimed present disclosure, from a study of the drawings, the disclosure, and the appended claims. The person skilled in the art realizes that the present disclosure is not limited to the preferred embodiments.

1. An electronic gaming arrangement to be positioned in relation to a gaming table, the gaming table comprising at least one of an active gaming area and a gaming device adapted to generate an outcome, the electronic gaming arrangement comprising:
a display screen adapted to present a graphical user interface (GUI),
an image capturing device,
a control unit connected to the display screen and the image capturing device,
a housing adapted to integrate the display screen, the image capturing device and the control unit, and
mounting means for arranging the electronic gaming arrangement in an elevated position in relation to at least one of the active gaming area and the gaming device, wherein the control unit is adapted to:
control the image capturing device to capture an image stream of at least one of a portion of the active area and the gaming device,
determine an outcome based on the captured image stream, and
distribute, using a networked connection, at least a portion of the image stream and the outcome to at least one of a first electronic device operated by a player or a server, the first electronic device and the server arranged remotely from the gaming table.

2. The electronic gaming arrangement according to claim 1, wherein the control unit is adapted to capture information indicative of wagering at the active gaming area.

3. The electronic gaming arrangement according to claim 2, wherein the control unit is further adapted to distribute at least a portion of the information indicative of wagering to the first remote electronic device.

4. The electronic gaming arrangement according to claim 1, wherein the control unit is further adapted to receive information indicative of wagering from the first remote electronic device.

5. The electronic gaming arrangement according to claim 1, wherein the housing comprises a top end and a bottom end, and the image capturing device is integrated in a vicinity of the top end of the housing.

6. The electronic gaming arrangement according to claim 1, wherein the control unit is further adapted to determine the outcome of the gaming device based on the image stream.

7. The electronic gaming arrangement according to claim 1, wherein an indication of the outcome of the gaming device is generated by sensor means comprised with the gaming table.

8. The electronic gaming arrangement according to claim 1, wherein the image capturing device comprises a first and a second image sensor, the first image sensor adapted to capture an image stream of the gaming device and the second image sensor is adapted to capture an image stream of the active area.

9. (canceled)

10. The electronic gaming arrangement according to claim 1, further comprising an audio capturing device adapted to capture an environmental sound at the gaming table, and the control unit is further adapted to distribute at least a portion of the audio stream to the first remote electronic device.

11. The electronic gaming arrangement according to claim 1, wherein the gaming device is a roulette wheel comprising a roulette ball.

12. The electronic gaming arrangement according to claim 1, wherein the gaming device is a dice-shaking device.

13. The electronic gaming arrangement according to claim 1, wherein the gaming device is an electronic card shuffler comprising a plurality of playing cards.

14. The electronic gaming arrangement according to claim 1, wherein the first remote electronic device comprises a receiver adapted to receive, over the networked communication, the image stream and the outcome to at least one first remote electronic device.

15. The electronic gaming arrangement according to claim 14, wherein the first remote electronic device further comprises a display screen adapted to present the image stream and the outcome.

16. The electronic gaming arrangement according to claim 1, wherein the control unit is adapted to implement server functionality.

17. The electronic gaming arrangement according to claim 1, wherein the remotely arranged server is a cloud server.

18. A gaming system, comprising:
a gaming table comprising an active gaming area and a gaming device adapted to generate an outcome, and
an electronic gaming arrangement according to claim 1.

19. (canceled)

20. The gaming system according to claim 18, wherein the gaming table comprises a multi-user touch interface.

21. The gaming system according to claim 18, further comprising at least one of a first electronic device and a server, the first electronic device and the server arranged remotely from the gaming table.

22. (canceled)

23. The gaming system according to claim 21, further comprising at least a second remote electronic device, wherein the second electronic device is at least one of a tablet, a mobile phone, or a personal computer.
